(19) United States
(12) Patent Application Publication
(10) Pub. No.: US 2010/0268717 A1
(43) Pub. Date: Oct. 21, 2010

(54) USE OF MOBILE DEVICES FOR VIEWING AND PUBLISHING LOCATION-BASED USER INFORMATION

(75) Inventor: Orest Pilskalns, Missoula, MT (US)

Correspondence Address: Rainier Patents, P.S., 505 W. Riverside Ave, Suite 440, Spokane, WA, 99201, US

(73) Assignee: GeoMonkey, Inc., Vancouver, WA (US)

(21) Appl. No.: 12/762,122

(22) Filed: Apr. 16, 2010

Related U.S. Application Data
(60) Provisional application No. 61/170,554, filed on Apr. 17, 2009.

(51) Int. Cl. G06F 3/01; G06F 17/30; G06F 15/16

(52) U.S. Cl. 707/754; 707/769; 715/753; 709/217; 707/E17.014

(57) ABSTRACT

The present application relates to the use of mobile devices for viewing and publishing location-based user information. One example allows a user of a mobile device to access content associated with a virtual version of an entity that exists at a physical location regardless of a location of the mobile device. This example enables the user to submit content to the virtual version when the mobile device is proximate the physical location.

### PRIORITY

This patent application claims priority from U.S. Provisional Application No. 61/170,554, filed on Apr. 17, 2009, which is incorporated by reference in its entirety.

### BACKGROUND

Numerous tools exist for electronically presenting geographic information to users. Very few tools exist for obtaining real-time geographic information from users. Many users have mobile devices from which they receive and transmit information to and from multiple digital locations. There are not many useful implementations linking this mobile user-transmitted data with actual geographical locations in a manner that would be useful to the user.

### SUMMARY

The present application relates to the use of mobile devices for viewing and publishing location-based user information.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 shows a scenario in which viewing and publishing of location-based user information relative to a mobile device can be employed in accordance with some implementations of the present concepts.

FIG. 2 shows a system that can accomplish viewing and publishing of location-based user information relative to a mobile device in accordance with some implementations of the present concepts.

FIGS. 3-7 are flowcharts for accomplishing viewing and publishing of location-based user information relative to a mobile device in accordance with some implementations of the present concepts.

### DETAILED DESCRIPTION

### Overview

The present application relates to the use of mobile devices for viewing and publishing location-based user information. In one example, a user may physically enter a place of interest. The place of interest may be associated with an entity, such as a business or organization. In one example, the place of interest (hereinafter, “physical location” or “geographical location”) can be a restaurant or sporting arena, among others. For purposes of explanation, the following discussion utilizes examples where the physical location is a business, but such need not be the case.

When the user enters the physical location, the user may at the same time, choose to (or by default) enter a virtual version of the business (hereinafter, “virtual business”) on the user's mobile device. The user may then enter content, such as a text-based comment or capture a digital picture, audio, video, review, or message on the mobile device and, in response, automatically transmit that content to a digital “wall” on the virtual business.

In some implementations, the user may only be allowed to access the physical location's virtual business when the user (and his/her mobile device) is proximate to, or within the physical location. Thus, the user may be on the business's property or in close proximity. For instance, in a food court scenario, the user may be allowed to post content to a virtual version of one of the restaurants of the food court even though the user may be seated in a common seating area.

In one example, the virtual version of the physical location may not even exist, until the user captures or generates data or information for that physical location, wherein after that, information is transmitted, and a “virtual wall” for the business is created. In some configurations, after creation of a new business virtual wall, all future users can see postings for that virtual wall and post to that virtual wall subject to some constraint. For instance, examples of constraints can be whether the user is within a certain range of the physical location of the business and/or whether the user has registered for the service.

In other scenarios, a place of interest, such as a business may have an existing virtual business, such as a web-site or virtual “wall”. Some implementations can adjust privileges to the user relative to the virtual business based upon the constraints. For instance, the user may be able to access the business's web-site from any physical location. However, access to on-site coupons or specials can be constrained based upon the user's physical location (i.e., the user can only see the on-site coupons or specials when the user (and the mobile device) are proximate the business's physical location.

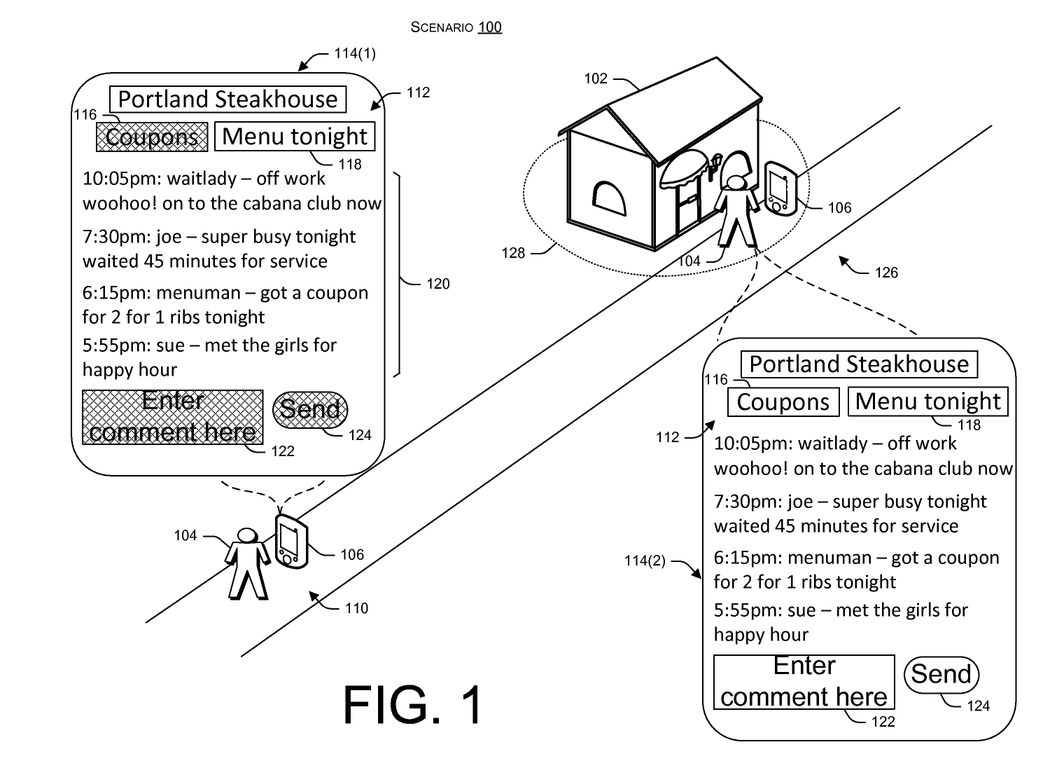

For introductory purposes consider FIG. 1 that describes viewing and publishing location-based user information in scenario 100. Scenario 100 involves a hypothetical business named ‘Portland Steakhouse’ that has a physical location indicated at 102. This scenario also involves a user 104 that has a mobile device 106.

At point 110, the user 104 is on his/her way to the physical location 102 but is not proximate the physical location. In this example, at point 110 the user can access virtual content associated with the Portland Steakhouse. For example, a virtual wall 112 of the Portland Steakhouse is displayed on mobile device 106 and shown on an enlarged display at 114(1). At this point, the user can see content on the virtual wall. The virtual wall 112 includes a ‘coupons’ dialog box 116, a ‘menu tonight’ dialog box 118, a comments section 120, an ‘enter comment’ dialog box 122, and a ‘send’ dialog box 124. However, some of the options presented on the virtual wall are unavailable to the user 104 at this point based upon one or more constraints. For instance, the user can see the ‘comments’ section 120 and access the ‘menu tonight’ dialog box 118. However, as indicated by cross-hatching, the user cannot access the ‘coupons’ dialog box 116, or enter a comment in the ‘enter comment’ dialog box 122. This inaccessibility can be based upon a constraint associated with the user's location relative to the business's physical location 102 (i.e., since the user is not proximate the physical location 102 the user's privileges relative to the content are constrained).

Subsequently, at point 126, the user reaches the physical location 102. In this implementation, at point 126 the user 104 can access the virtual business associated with the Portland Steakhouse with enhanced privileges relative to the virtual business. Stated another way, at point 126 the user 104 enters, or is proximate to, the physical location 102 as indicated by dotted line 128. At point 126, the user may be automatically given privileges (or constraints lifted) associated with the virtual business based upon the user's location being proximate to the physical location. In this example, the user can access additional content and/or features in the virtual business based upon the proximity. Specifically, in enlarged display 114(2) the ‘coupons’ dialog box 116, ‘enter comment’ dialog box 122, and ‘send’ dialog box 124 are now available to the user.

The above discussed implementations can provide several potential advantages. For instance, these configurations can produce more reliable content on the virtual business. For example, limiting comment posting to users that are actually at the business can reduce the chances that pranksters or competing businesses might post inaccurate comments.

Some implementations can offer still other virtual features relative to the user's location. For instance, assume that a coffee shop has an offer where upon purchasing nine coffees, the tenth is free. This offer can be manifest as a virtual punch card that is much more convenient than a traditional paper punch card. Each time the user visits the coffee shop, the coffee shop's virtual wall can be automatically presented on the user's mobile device based upon location information. The virtual wall can include the virtual punch card. The user could click on the virtual punch card or the virtual punch card could be automatically presented to the user on the virtual wall. For instance, the virtual punch card can be presented on the virtual wall as a dialog box that says “Dear user-since you are at the coffee shop please have your virtual account punched (i.e. credited).”

The process could be rather simple, such as an employee who rings-up the user enters a unique identification for the user and a number of coffees purchased. The information can be uploaded to a service that manages the virtual wall to credit the user's account. A more automated configuration may automatically determine the user's identity such as through the user's credit card and correlate the identity with the number of coffees charged to the user (such as based upon SKUs). This information could then be utilized to credit the user's virtual punch card.

The above described virtual punch cards avoid the user having to carry around a bunch of cards and to sort through them, etc. Further, these implementations can ‘follow the user’ in situations where the business has multiple locations, further avoiding the typical scenario where the user leaves their paper punch card at their favorite location and then doesn't have it when they go to a different location.

In summary, there is great value to users of a business or other gathering place (school, sports arena, park or outdoor locale) to view and post information specific to that locale, in real-time, from a mobile device. In some implementations this feature may be provided automatically to the user. For instance, in the Portland Steakhouse example, when the user reaches the physical location 102, the virtual business's web-site or virtual wall may be automatically launched on the user's mobile device based upon location information obtained from the mobile device. In another example, when a user enters a stadium for a sporting event, a virtual wall of the league hosting the event, home team, and/or visiting team may automatically be displayed on the user's mobile device without any effort by the user. Access to and/or privileges associated with the virtual wall may be constrained based upon the user's physical location.

### System Example

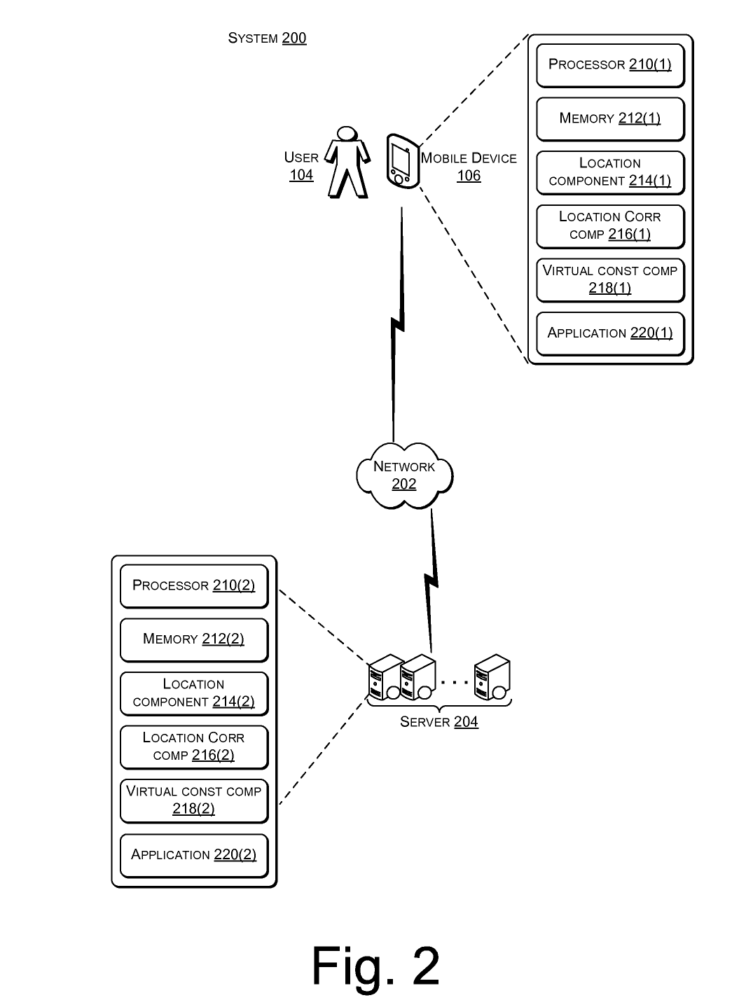

FIG. 2 depicts an illustrative architecture or system 200 configured to support viewing and publishing of location-based user information. System 200 includes mobile device 106 that can be associated with user 104. System 200 also includes network 202 and a server 204. Mobile device 106 can be any sort of device that has some processing capability and a capability to communicate over a network such as network 202. For instance, mobile device 106 may be a mobile phone, a personal digital assistant (PDA), a laptop computer, a portable media player (PMP) (e.g., a portable video player (PVP), a digital audio player (DAP), etc.), or any other type of existing, evolving, or yet to be developed computing device.

Meanwhile, network 202, which is configured to couple mobile device 106 and server 204, may comprise the Internet, a Local Area Network (LAN), a Wide Area Network (WAN), a wireless network, and/or the like. Here, network 202 may comprise a wireless cellular network or a wireless fidelity (Wi-Fi) network. Also, while only a single network is illustrated, the system may entail multiple networks.

As illustrated, either or both of mobile device 106 and server 204 can include one or more processors 210, memory 212, location component 214, location correlation component 216, virtual constraint component 218 and/or application(s) 220. Processor 210 can execute computer readable instructions, such as may be stored on memory 212, to cause a method to be performed.

Location component 214 can be configured to periodically and/or from time-to-time identify the location of mobile device 106. For instance, location component 214 can employ GPS technologies and/or Wi-Fi triangulation technologies, among others, to identify the location of mobile device 106. In some cases, the location of the mobile device can be identified on the mobile device by location component 214(1). In other configurations, the mobile device's location can be identified remotely by location component 214(2).

The mobile device's identified location can be communicated to location correlation component 216. The location correlation component can compare the mobile device's location to a location of a place of interest. The location of the place of interest can be determined in the same way as the location of the mobile device and/or be referenced in a look-up table. Stated another way, location correlation component 216 can determine whether the mobile device is proximate to a physical location. For instance, the user 104 may be using application 220 to surf a web-site associated with the physical location.

The location correlation component 216 can determine whether the mobile device 106 is proximate the physical location and communicate that information to the virtual constraints component 218. The virtual constraints component can authorize access to the web-site and/or subject the access to constraints, such as the proximity of location, received from the location correlation component 216. An example of such constrained access is described above relative to FIG. 1.

In some instances, the virtual constraints component 218 may be thought of as a component that manages virtual business and users. For instance, the virtual constraints component may include a mapping of businesses or other places of interest, their physical location, and their virtual content. The virtual constraints component may also maintain a mapping of users that are interested in receiving location specific virtual content. The virtual constraints component can then match users to virtual content based upon the users' physical location information obtained from location component 214.

Stated another way, system 200 enables strategies for annotating a digital space inside a virtual business or gathering place, among others. In some configurations, the system can aggregate geo-located information in real time from users' mobile devices, such as mobile device 106. The aggregated geo-located information can be stored on computer-readable media, such as memory 212, with computer-executable instructions related to that computer-readable media. The computer-readable media can occur on mobile devices and/or on remote computing devices, such as server 204. In some implementations, the geo-located information can be automatically retrieved when an individual mobile device user enters a geographic area that corresponds to the geo-located information.

According to one exemplary aspect, the strategy can involve uploading to a computing device, such as server 204, an object(s) in response to a first instruction. For example, user 104 can issue the first instruction from mobile device 106 when he/she desires to upload an object or other content. In another instance, the first instruction may be issued automatically when the user enters an area associated with the physical business. Server 204 can store the object based upon the location of the mobile device 106 that captured the object. The object may correspond to a text message, digital photograph, media file, photo, video, audio, and so on.

In some implementations, the user location is determined using a location service provided by location component 214(1) on the mobile device 106, such as global positioning system (GPS) or Wi-Fi triangulation. In some cases, the user location may be determined based on user input of address or latitude/longitude coordinates. The strategy further involves, in response to a second instruction, linking the uploaded object to a selected location (or default location) within the virtual business, to thereby provide an annotated “wall”. The second instruction can be issued automatically or can be user generated. For instance, if the user's location is proximate to several businesses (i.e., physical locations), the user may specify which corresponding virtual business the object should be associated with. In this strategy, the linking can take place by associating the object with the geographical location and sending the combined information to the server 204.

If the virtual business associated with a physical location does not already exist in the server 204, it can be automatically created on the server. Any other user that enters the virtual business can see postings to the digital “wall” (potentially subject to the constraints) by automatically communicating with the server. In some implementations, a query from mobile devices can use location and returned postings that can be constrained to only that location.

In another example, user 104 may enter a physical location of a business and at the same time, enter a virtual version of the business on the user's mobile device 106. The virtual entrance may trigger an action on behalf of the business wherein the user may then receive information related to the business on the user's mobile device. In this case, the information transmitted to the user's mobile device may be coupons or messaging related to specials or relating to other users who have recently entered the business. In another aspect, the user may initiate the receipt of coupons, messaging or other information from the business to the user's mobile device.

According to another exemplary inventive aspect, the strategy can involve giving the user the option of viewing their digital postings at a later date, either from mobile device 106 or from a computer online interface. The user could in fact view their own historical postings via a private or password-protected web interface that displays their postings on an annotated map, based on the geographical location at which they were captured.

In another example, the owner of the business may receive access to the digital information posted by mobile users on the virtual business, and may be granted access to edit and modify the presence of the virtual business within the system. One example of this may include modifying the look and feel of the virtual business' interface to resemble the physical representation of the business. The owner may also choose to define, such as using an online interface, a geographical boundary around the business. In some implementations, the geographical boundary can be stored as the business location utilized by the location correlation component 216(2). Subsequently, digital postings (or a filtered sub-set thereof) within that geographical boundary (i.e., in a defined area) can be posted to the virtual wall of that business. Virtual boundaries may be created automatically when a user first posts a message. A k-means clustering algorithm is one approach that may be applied in order to auto-define boundaries, if a previous bounds is not defined.

In another scenario, assume for purposes of explanation that two or more users are posting information to a virtual “wall” at approximately the same time. The users' mobile devices can indicate that the users or “posters” are currently in the same area. In some cases, the system can allow the users to communicate via a “chat” interface. In some instances, the chat interface may be limited to the posters (i.e., private). In this example, the digital interactions may provide opportunity for person-to-person digital interaction, as well as in-person interactions.

In another example, users viewing the content on a virtual wall may be able to rate that content using a nominal scale. The ratings may be used to help determine the ordering of the virtual wall postings. Other considerations for ordering the wall postings could include time of posting, length of posting, and ratings on previously rated postings. Postings can be anonymous or associated with a user account.

In another example, the posted information may be viewed from a web interface in the form of a “hot spots” map, wherein clusters of postings may appear as “hot spots” on the geographical location.

Another scenario involving location-based user information can involve linking the virtual business to physical transactions. For example, once a person enters a virtual business, he/she can also access links to pay for parking, for example, or reserve a table, a tee time, or purchase items or merchandise. A further scenario can involve linking the virtual business to other information so a user could access local travel info, history, etc. Still another scenario can involve linking the virtual business to other businesses nearby (i.e. users at a concert venue could find the nearest restaurant or coffee shop). Another scenario can involve sub-domains within a virtual business, such as various holes on a golf course, independent buildings within a complex (i.e. library on a college campus), sections of an airport, etc.

### Method Examples

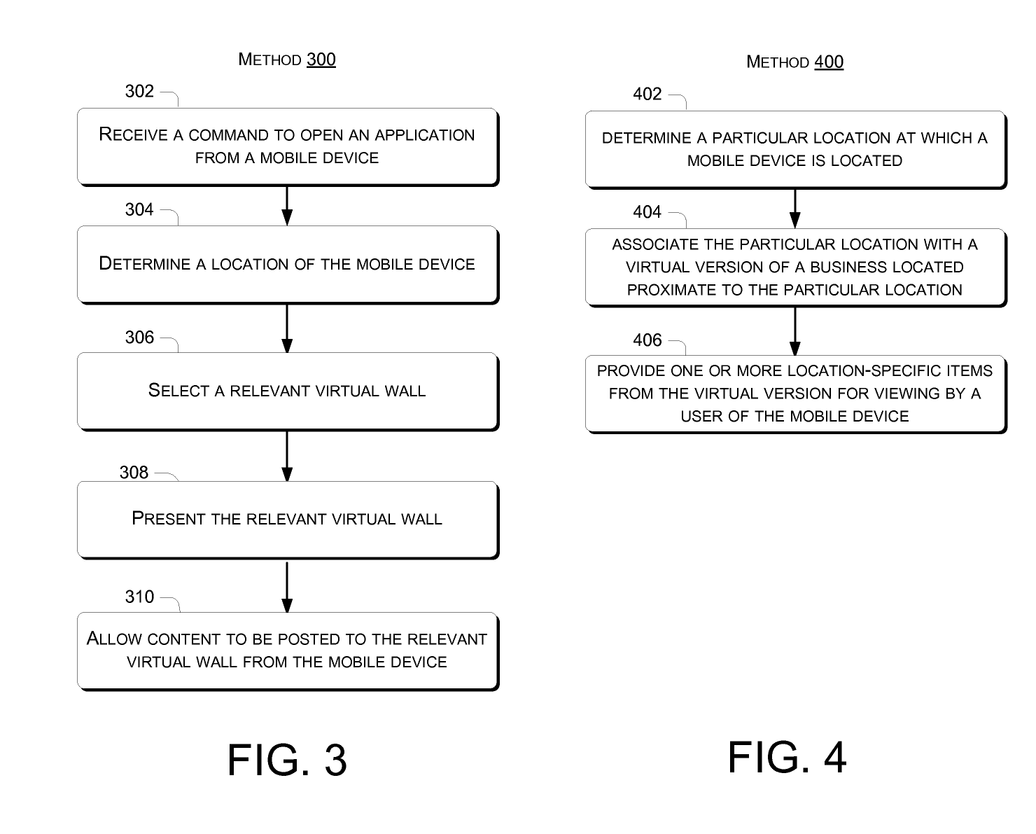

FIG. 3 illustrates a flowchart of a process, technique, or method 300 that is consistent with at least some implementations of the present location-based user information concepts.

At block 302, the method receives a command to open an application from a mobile device. In some cases, the application may be a web browser application or a social networking application. The application may be resident on the mobile device or may be resident on a server device that is communicatively linked with the mobile device.

At block 304, the method determines a location of the mobile device. Various techniques can be employed to determine the location. Non-limiting examples are described above relative to FIG. 2.

At block 306, the method selects a relevant virtual wall. The relevant virtual wall can be selected by correlating a location of the mobile device with a virtual wall of a place of interest that is proximate to the location of the mobile device.

At block 308, the method presents the relevant virtual wall. For instance, the relevant virtual wall can be presented on the mobile device. When the mobile device is proximate a physical business corresponding to the virtual wall, the virtual wall may be presented with less constraints than when the mobile device is not proximate the location of the physical business.

At block 310, the method allows content to be posted to the relevant virtual wall from the mobile device. The privilege of posting content to the virtual wall may be removed when the user leaves the location of the physical business.

FIG. 4 illustrates a flowchart of a process, technique, or method 400 that is consistent with at least some implementations of the present location-based user information concepts.

At block 402, the method determines a particular location at which a mobile device is located.

At block 404, the method associates the particular location with a virtual version of a business located proximate to the particular location.

At block 406, the method provides one or more location-specific items from the virtual version for viewing by a user of the mobile device. For instance, ‘on-site’ coupons or specials may be presented for viewing.

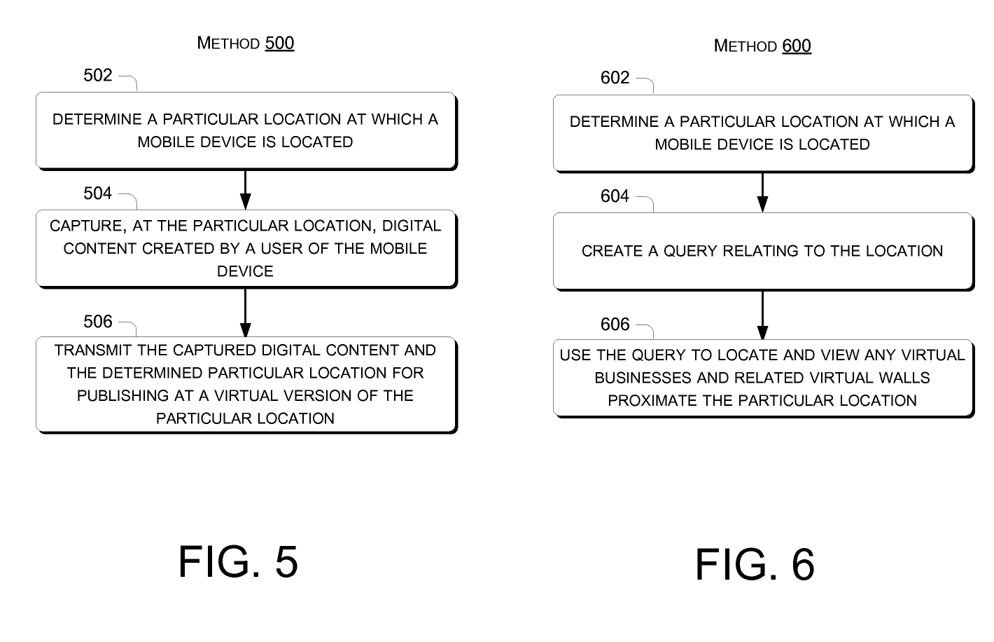

FIG. 5 illustrates a flowchart of a process, technique, or method 500 that is consistent with at least some implementations of the present location-based user information concepts.

At block 502, the method determines a particular location at which a mobile device is located.

At block 504, the method captures, at the particular location, digital content created by a user of the mobile device. In some implementations, the capture may only be allowed when the particular location corresponds to a physical location of the place of interest.

At block 506, the method transmits the captured digital content and the determined particular location for publishing at a virtual version of the particular location.

FIG. 6 illustrates a flowchart of a process, technique, or method 600 that is consistent with at least some implementations of the present location-based user information concepts.

At block 602, the method determines a particular location at which a mobile device is located.

At block 604, the method creates a query relating to the location.

At block 606, the method uses the query to locate and view any virtual businesses and related virtual walls proximate the particular location.

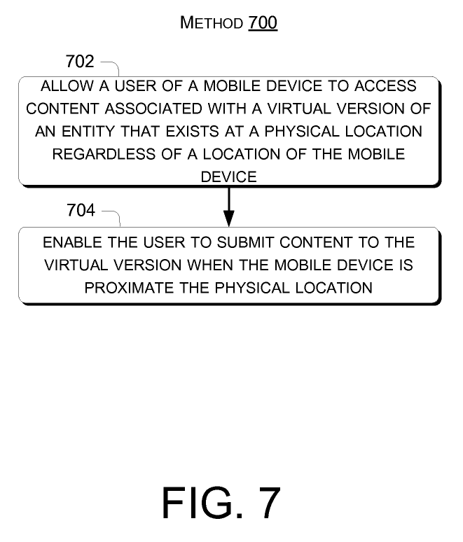

FIG. 7 illustrates a flowchart of a process, technique, or method 700 that is consistent with at least some implementations of the present location-based user information concepts.

At block 702, the method allows a user of a mobile device to access content associated with a virtual version of an entity that exists at a physical location regardless of a location of the mobile device.

At block 704, the method enables the user to submit content to the virtual version when the mobile device is proximate the physical location.

The order in which the above listed methods are described is not intended to be construed as a limitation, and any number of the described blocks or acts can be combined in any order to implement the method, or an alternate method. Furthermore, the method can be implemented in any suitable hardware, software, firmware, or combination thereof such that a computing device can implement the method and/or cause the method to be implemented. In one case, the method is stored on a computer-readable storage media as a set of instructions such that execution by a computing device causes the method to be performed.

1. One or more computer-readable media storing computer-executable instructions that, when executed on one or more processors, perform acts comprising:
determining a particular location at which a mobile device is located;
associating the particular location with a virtual version of a business located proximate to the particular location; and,
providing one or more location-specific items from the virtual version for viewing by a user of the mobile device.

2. The computer-readable media of claim 1, wherein the associating comprises associating the particular location with multiple businesses that are proximate to the particular location and allowing the user to select an individual business of the multiple businesses from which to view the location-specific items.

3. The computer-readable media of claim 1, wherein the particular location is on property controlled by the business.

4. The computer-readable media of claim 1, wherein at least some of the location-specific items are submitted by the user or other users from the business.

5. The computer-readable media of claim 1, wherein the location-specific items can only be submitted to the virtual version by the user or other users from the business.

6. A server computing device that includes the computer-readable media of claim 1.

7. One or more computer-readable media storing computer-executable instructions that, when executed on one or more processors, perform acts comprising:
determining a particular location at which a mobile device is located;
capturing, at the particular location, digital content created by a user of the mobile device; and,
transmitting the captured digital content and the determined particular location for publishing at a virtual version of the particular location.

8. The computer-readable media of claim 7, wherein the captured digital content is a unit of text, a photograph, audio file, video file, or other item.

9. The computer-readable media of claim 7, wherein the publishing comprises publishing to an annotated digital interface, a mobile interface, a digital map, a web page or other users who frequent the particular location.

10. A system comprising the computer-readable media of claim 7.

11. One or more computer-readable media storing computer-executable instructions that, when executed on one or more processors, performs acts comprising:
determining a particular location at which a mobile device is located;
creating a query relating to the particular location; and,
using the query to locate and view virtual businesses and related virtual walls proximate the particular location.

12. The computer-readable media of claim 11, wherein the query is filterable based on at least one parameter.

13. The computer-readable media of claim 12, wherein the at least one parameter is time.

14. A system comprising the computer-readable media of claim 11.

15. A server computing device comprising the computer-readable media of claim 11.

16. One or more computer-readable media storing computer-executable instructions that, when executed on one or more processor, performs acts comprising:
allowing a user of a mobile device to access content associated with a virtual version of an entity that exists at a physical location regardless of a location of the mobile device; and,
enabling the user to submit content to the virtual version when the mobile device is proximate the physical location.

17. The computer-readable media of claim 16, wherein the virtual version comprises a virtual wall.

18. The computer-readable media of claim 16, wherein in an instance where the entity exists at multiple physical locations then the allowing comprises allowing the user to select to access the virtual version associated with an individual physical location.

19. A server computing device comprising the computer-readable media of claim 16.

20. A system comprising the computer-readable media of claim 16.
